(19) United States
(12) Patent Application Publication
(10) Pub. No.: US 2009/0072637 A1
(43) Pub. Date: Mar. 19, 2009

(54) AIRFLOW GENERATOR

(75) Inventors: Liang-Sheng CHANG, Hengshan Township (TW); Te-Chang Chou, Hukou Township (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/855,046

(22) Filed: Sep. 13, 2007

(51) Int. Cl. H02K 33/00

(52) U.S. Cl. 310/36

(57) ABSTRACT

The airflow generator includes a plate having a pivot and a swinging end. The invention also includes a first magnetic induced portion assembled nearby the pivot opposite to a second magnetic induced portion. With magnetic induced change, the first and second magnetic induced portions generate magnetic attraction or repulsion to drive the swinging end. The innovative airflow generator of the present invention can be applied to a compact structure and yield a satisfactory heat radiation effect and widely applied to the heat-radiating structure of various small-sized electronic devices.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an airflow generator, and more particularly to an innovative airflow generator with a plate swinging to generate airflow by a magnetic induction principle.

2. Description of Related Art Including Information Disclosed Under 37 CFR 1.97 and 37 CFR 1.98.

Electronic devices will generate heat depending upon size and capacity. Currently, radiator fans are commonly used for electronic devices, which will become more compact in response to thin-profile development of electronic devices. However, a radiator fan generally comprises a rotor, a stator and an annular blade, providing a limitation for space saving. Moreover, when the annual blade is reduced to a certain volume, the heat radiation effect will become poorer in addition to difficult die sinking and high rates of defective construction. Thus, such radiator fans are mostly applied to desktop or notepad computers where space is at a premium. Given the fact that some relevant electronic and telecom devices (e.g. mobile phone, PDA, and digital camera) develop quickly with respect to their functionality, and that the operating capability of processors is also increased markedly, the heat generated by compact electronic devices will increase greatly. That is to say, existing electronic notepad devices are exposed to high temperatures, leading to possible damage of components, shorter service life and greater hazards. So, improved heat radiation mechanisms are required to be introduced. Owing to the space limitation and the rotary blade of the aforementioned radiator fan, it is difficult to achieve efficient heat radiation in compact electronic devices.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The airflow generator of the present invention is an innovation, including a plate, a magnetic brake unit and a housing. Unlike the conventional radiator fan, the magnetic change of the first and second magnetic induced portions are controlled to generate magnetic attraction or repulsion to drive the swinging end of the plate for yielding swinging motion. As compared with a conventional radiator fan of the prior art, the volume of the present invention is minimized while a satisfactory heat radiation effect is achieved. Overcoming the disadvantages and bottlenecks encountered previously, the airflow generator of the present invention will be widely applied to the heat-radiating structures of compact electronic devices (e.g. mobile phone, PDA and digital camera), helping achieve efficient heat radiation with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the preferred embodiment of the present invention.

FIG. 2 shows another schematic view of another side of the preferred embodiment of the present invention.

FIG. 3 shows a schematic view of the operation of the present invention.

FIG. 4 shows a schematic view of preferred embodiment of the present invention which is applied to electronic device.

FIG. 5 shows another schematic view of the operation of first and second magnetic induced portions of the present invention.

FIG. 6 shows a schematic view of the present invention equipped with housing.

FIG. 7 shows another schematic view of the present invention equipped with housing.

FIG. 8 shows a schematic view of the preferred embodiment of FIGS. 6, 7 of the present invention which is applied to the electronic device.

FIG. 9 shows a sectional view of another application of housing of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

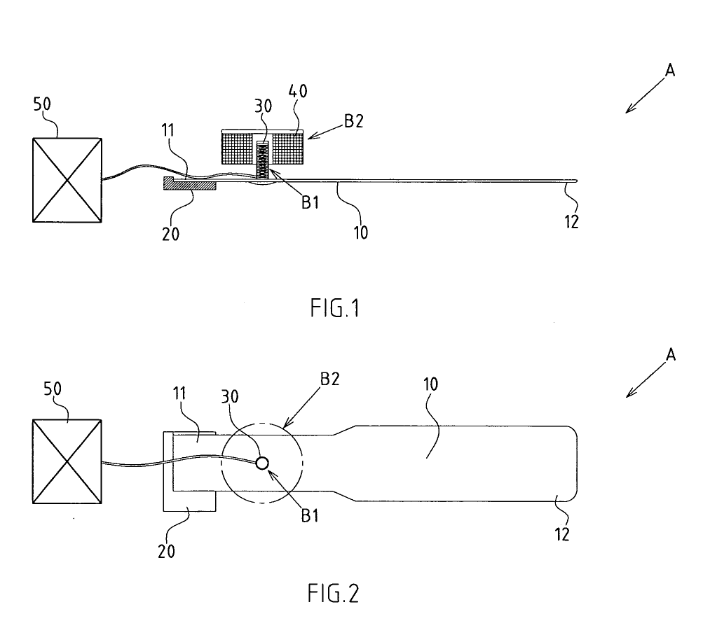

FIGS. 1-2 depict preferred embodiments of airflow generator of the present invention. The embodiments are provided only for explanatory purposes. The scope of the invention is set by the patent claims.

The airflow generator A includes a plate 10, formed by a long flat bar of predefined thickness. This plate 10 contains a pivot 11 and a swinging end 12 far away from the pivot 11. A first magnetic induced portion B1 is assembled at a preset location nearby the pivot 11. A second magnetic induced portion B2 is assembled opposite the first magnetic induced portion B1 of said plate 10. The first and second magnetic induced portions B1, B2 generate magnetic attraction or repulsion to drive the swinging end 12 of the plate 10.

The pivot 11 of the plate 10 is molded to the permanent seat 20 by means of fusion, bonding, bolting, riveting, gripping, molding or high-frequency pressing.

Referring to FIGS. 1 and 2, said first magnetic induced portion B1 is made of coil 30, while the second magnetic induced portion B2 is made of corresponding magnet 40. The first magnetic induced portion B1 is linked to a controller 50, which is used to control the magnetic change of coil 30 of the first magnetic induced portion B1.

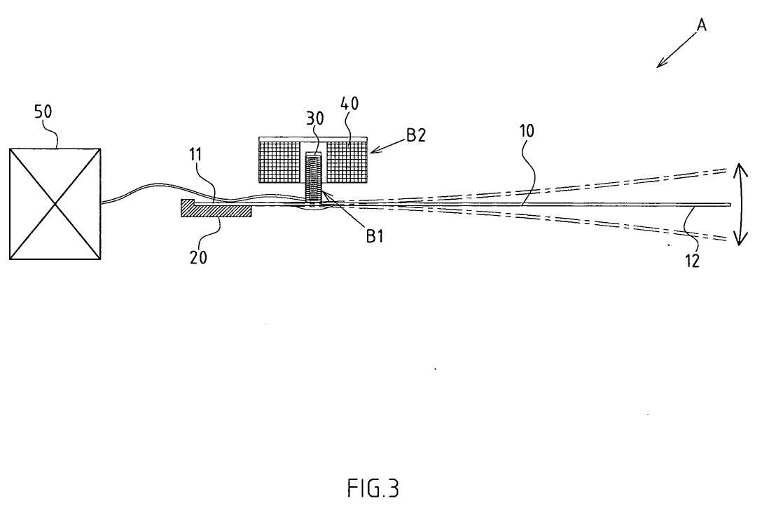

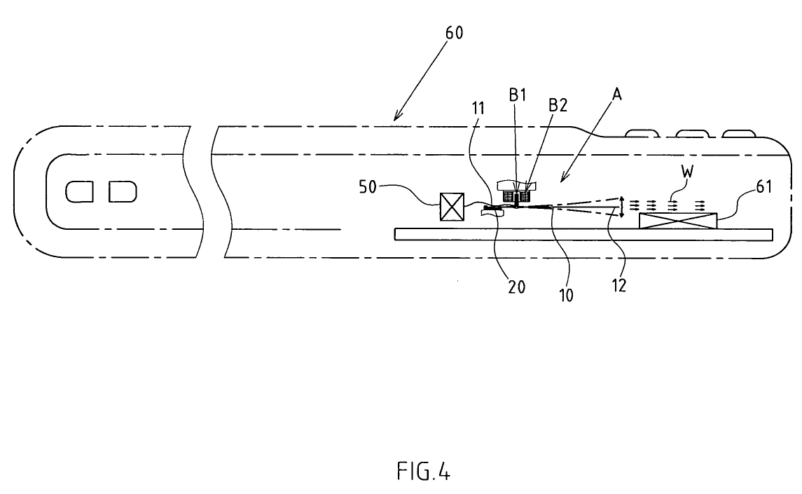

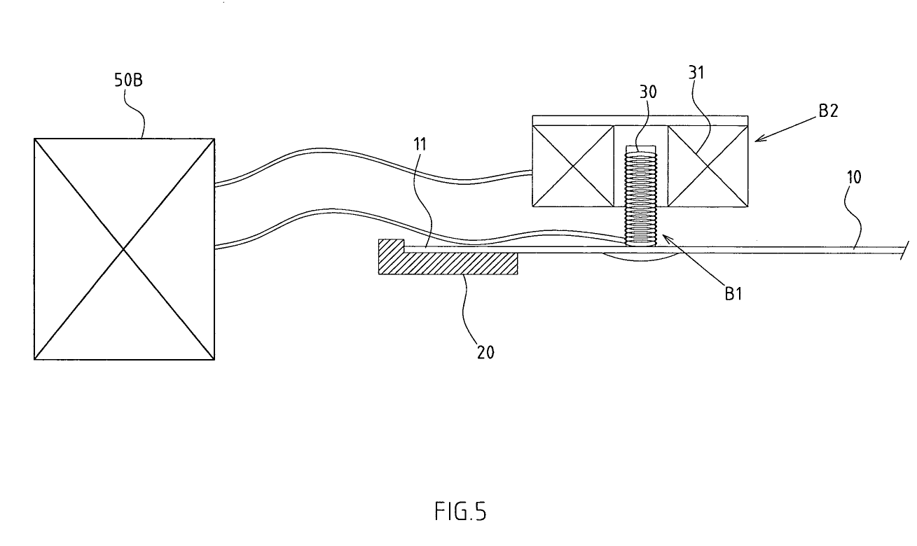

Referring to FIGS. 3 and 4, in the airflow generator A, the plate 10 and first, second magnetic induced portions B1, B2 are assembled into a preset electronic device 60 nearby the processor 61 of mobile phone, PDA and digital camera, etc. The controller 50 is used to control the magnetic change of the first magnetic induced portion B1, so as to generate magnetic attraction or repulsion to drive the swinging end 12 of the plate 10 for yielding swinging motion and airflow (shown in arrow W in FIG. 4), thus achieving heat radiation for the processor 61 of electronic device 60.

Referring to FIG. 5, said first and second magnetic induced portion B1 B2 are also made of coils 30, 31, so that the first and second magnetic induced portions B1, B2 are linked to the same controller 50B for controlling the magnetic change of coils 30, 31 of the first and second magnetic induced portions B1, B2.

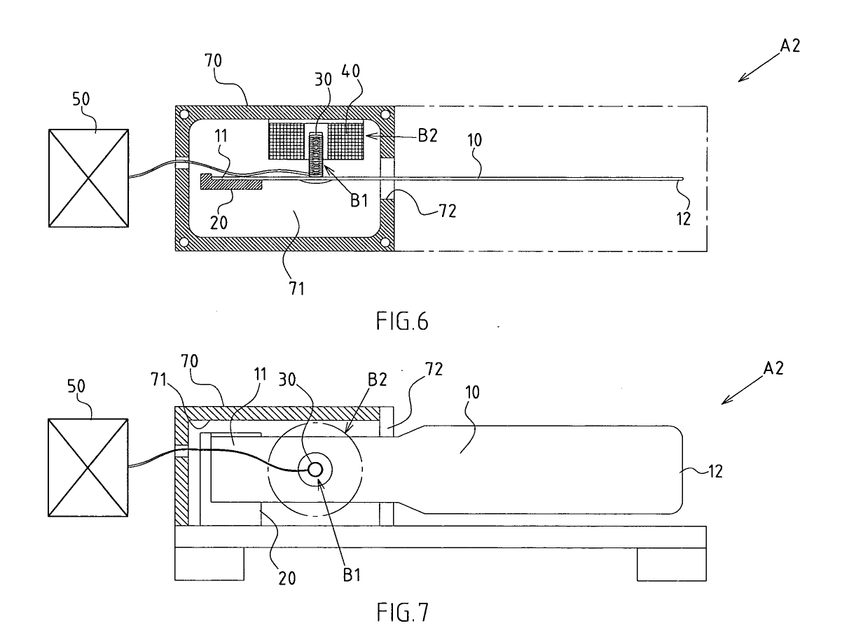

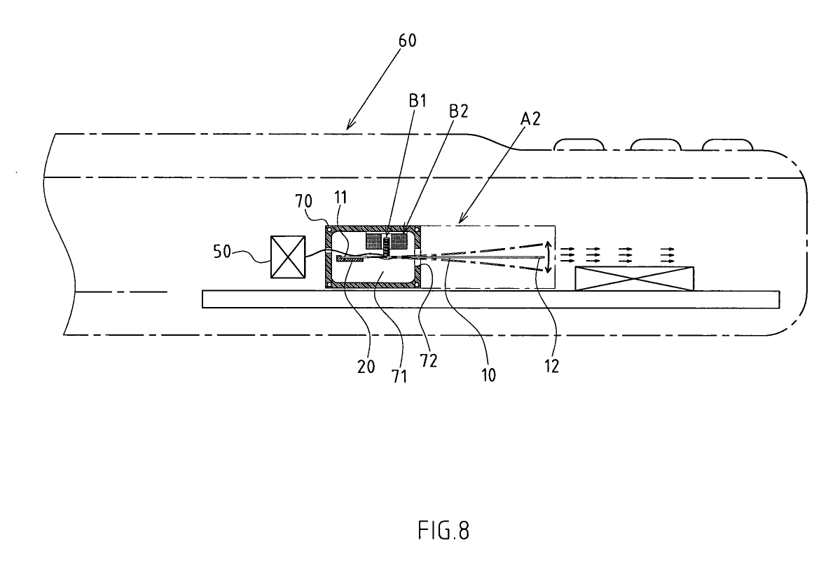

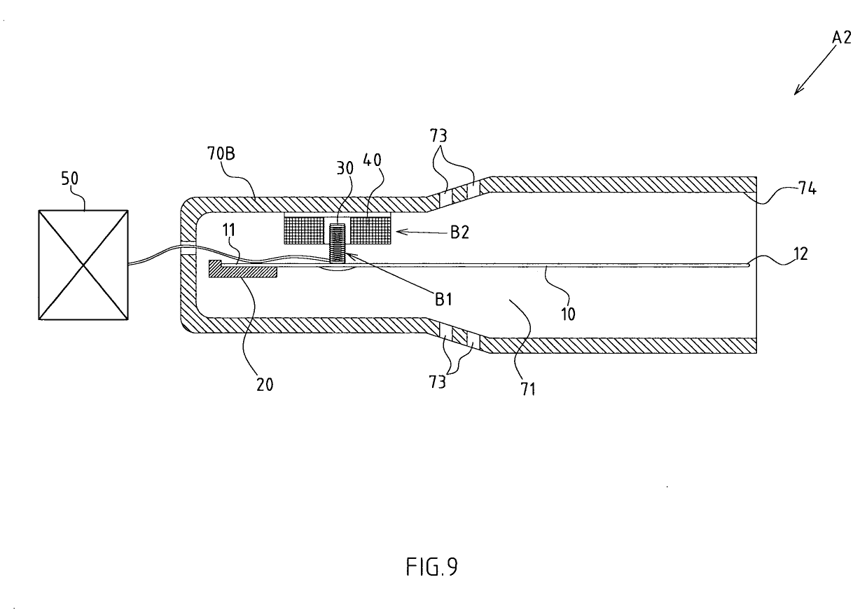

Furthermore, the preferred embodiment of the airflow generator of the present invention is also shown in FIGS. 6 and 7, wherein the airflow generator A2 comprises a housing 70, which has an inner space 71 for accommodating the pivot 11 of said plate 10. At one end of the housing 70, an opening 72 is used for penetration or alignment of swinging end 12 of the plate 10. Referring to FIG. 8 for this preferred embodiment, airflow generator A2 is assembled at a location nearby the processor 61 of the electronic device 60, so that the housing 70 and electronic device 60 could be positioned securely. Moreover, the housing 70 could also used for inflow/outflow guide of air current. Referring to FIG. 9, the housing 70B is provided with air inlets 73 at a lateral location and air outlet 74 corresponding to the swinging end 12 of the plate 10. When the swinging end 12 of the plate 10 is activated, air current is guided from air inlet 73 into the inner space of the housing 70B, and then guided out from air outlet 74. Thus, when the airflow generator A2 is assembled in the electronic device, the heat radiation effect could be achieved by aligning air inlet 73 with the heat source (e.g. processor), and connecting air outlet 74 to the exterior of the electronic device.

1. An airflow generator, comprising:
a plate, being formed by a long flat bar of predefined thickness and having a pivot and a swinging end, said swinging end being located at a distance from said pivot;
a first magnetic induced portion, assembled at a preset location nearby said pivot; and
a second magnetic induced portion, assembled opposite to said first magnetic induced portion of said plate, wherein magnetic attraction or repulsion generated by the first and second magnetic induced portions drive said swinging end of said plate.

2. The generator defined in claim 1, further comprising:
a permanent seat, said pivot being molded onto said permanent seat.

3. The generator defined in claim 2, wherein said pivot and said permanent seat are fastened by fusion, bonding, bolting, riveting, gripping, molding or high-frequency pressing.

4. The generator defined in claim 1, wherein said first magnetic induced portion is comprised of coil, said second magnetic induced portion being comprised of a corresponding magnet, said first magnetic induced portion being linked to a controller, and wherein magnetic change of said coil of said first magnetic induced portion is controlled by said controller.

5. The generator defined in claim 1, wherein the first and second magnetic induced portions are comprised of coils, the first and second magnetic induced portions being linked to a single controller, and wherein magnetic change of said coils of the first and second magnetic induced portions are controlled by said single controller.

6. An airflow generator, comprising:
a plate, being formed by a long flat bar of predefined thickness and having a pivot and a swinging end, said swinging end being located at a distance from said pivot;
a first magnetic induced portion, assembled at a preset location nearby said pivot;
a second magnetic induced portion, assembled opposite to said first magnetic induced portion of said plate, wherein magnetic attraction or repulsion generated by the first and second magnetic induced portions drive said swinging end of said plate; and
a housing, having an inner space accommodating said pivot of said plate and an opening for penetration or alignment of said swinging end of said plate.

7. The generator defined in claim 6, further comprising:
a permanent seat, said pivot being molded onto said permanent seat, said permanent seat being assembled and positioned on a predefined location of said housing.

8. The generator defined in claim 7, wherein said pivot and said permanent seat are fastened by fusion, bonding, bolting, riveting, gripping, molding or high-frequency pressing.

9. The generator defined in claim 6, wherein said first magnetic induced portion is comprised of coil, said second magnetic induced portion being comprised of a corresponding magnet, said first magnetic induced portion being linked to a controller, and wherein magnetic change of said coil of said first magnetic induced portion is controlled by said controller.

10. The generator defined in claim 6, wherein the first and second magnetic induced portions are comprised of coils, the first and second magnetic induced portions being linked to a single controller, and wherein magnetic change of said coils of the first and second magnetic induced portions are controlled by said single controller.
